(19) United States
(12) Patent Application Publication
(10) Pub. No.: US 2023/0036403 A1
(43) Pub. Date: Feb. 2, 2023

(54) LIQUID CRYSTAL DISPLAY PANEL AND DISPLAY DEVICE

(71) Applicant: HKC CORPORATION LIMITED, Shenzhen (CN)

(72) Inventors: Shishuai HUANG, Shenzhen (CN); Haoxuan ZHENG, Shenzhen (CN)

(73) Assignee: HKC CORPORATION LIMITED, Shenzhen (CN)

(21) Appl. No.: 17/850,410

(22) Filed: Jun. 27, 2022

(30) Foreign Application Priority Data
Jul. 30, 2021 (CN) 202110876461.5

(51) Int. Cl. G02F 1/1343; G02F 1/1335; G02F 1/1362

(52) U.S. Cl. CPC G02F 1/134309; G02F 1/133514; G02F 1/133512; G02F 1/136286; G02F 2202/22; G02F 2201/50

(57) ABSTRACT

A liquid crystal display panel and a display device, where the liquid crystal display panel includes a color film substrate and an array substrate, the color film substrate includes a first base substrate and a first electrode layer arranged on the first base substrate, the array substrate includes a second base substrate and a second electrode layer arranged on the second base substrate, a distance between the second electrode layer and the first electrode layer is greater than or equal to a threshold value; the threshold value is a critical safety distance that causes a generation of arc discharge between the first electrode layer and the second electrode layer. According to the embodiments, a problem that the existing liquid crystal display panel has a weak anti-static-electricity ability, so that electrodes of the liquid crystal display panel are prone to be damaged is solved.

### CROSS-REFERENCE TO RELATED APPLICATIONS

Pursuant to 35 U.S.C. § 119 and the Paris Convention Treaty, this application claims the benefit of Chinese patent application No. 202110876461.5 filed Jul. 30, 2021, and entitled “liquid crystal display panel and display device”, the contents of which are incorporated herein by reference in entirety.

### TECHNICAL FIELD

The present application relates to the field of display technology, and more particularly to a liquid crystal display panel and a display device.

### BACKGROUND

At present, in order to increase an aperture ratio of a liquid crystal display panel in use, it is common practice in the art to arrange RGB (Red, Green, Blue) color resists on the side of TFT (Thin Film Transistor), two adjacent color resists are overlapped, data wires are arranged at a position where the color resists are overlapped, and a shielded electrode layer is arranged on the surface (i.e., above the data wires) of the position where the color resists are overlapped so as to shield a stray capacitance between the data wires and an electrode on a color film substrate.

However, since the shielded electrode is extended from a display region of the liquid crystal display panel to a non-display region of the liquid crystal display panel extended along the data wires, the non-display area is provided with a light shielding layer, and a height where the color resists are overlapped is greater than a height of a single color resist, so that a distance between the shielded electrode and the electrode on the color film substrate is reduced; when a static test with thousands kilovolts is performed on the periphery of the liquid crystal display panel, the electrode on the color film substrate will begin to absorb static electricity from the edge thereof, in this situation, the voltage at the edge of the electrode on the color film substrate is very high, while the distance between the shielded electrode and the electrode on the color film substrate is reduced, so that an arc discharge is prone to be generated between the shielded electrode and the electrode on the color film substrate, explosion of the shielded electrode, the damage to the shielded electrode due to the explosion and the influence of the explosion on the displaying of the liquid crystal display panel are further caused.

### SUMMARY

An objective of the embodiments of the present application is to provide a liquid crystal display panel and a display device, in the liquid crystal display panel, the distance between the first electrode layer of the color film substrate and the second electrode layer of the array substrate is set to be a safety distance that does not cause a generation of arc discharge, so that a problem that the existing liquid crystal display panel has a weak anti-static-electricity ability, and the electrodes of the liquid crystal display panel are prone to be damaged is solved.

In order to achieve the objective described above, a liquid crystal display panel is provided in the present application, this liquid crystal display panel includes:

a color film substrate and an array substrate the color film substrate includes a first base substrate and a first electrode layer arranged on the first base substrate, the array substrate includes a second base substrate and a second electrode layer arranged on the second base substrate;

a distance between the second electrode layer and the first electrode layer is greater than or equal to a threshold value, and the threshold value is a critical safety distance that causes a generation of an arc discharge between the first electrode layer and the second electrode layer.

According to the liquid crystal display panel according to the embodiment of the present application, the distance between the first electrode layer of the color film substrate and the second electrode layer of the second array substrate is set to be greater than or equal to the threshold value which is the critical safety distance that causes the generation of arc discharge between the first electrode layer and the second electrode layer, so that the arc discharge won't be generated between the first electrode layer and the second electrode layer after absorption of static electricity by the first electrode layer, and an anti-static-electricity ability of the liquid crystal display panel is enhanced, an explosion of the second electrode layer and a damage to the second electrode layer due to the explosion is further avoided, and a condition that a splashing point generated due to the explosion of the second electrode layer falls within the display region of the liquid crystal display panel, and thereby affects a normal display of the liquid crystal display panel is effectively avoided.

In one embodiment, the threshold value is 3 micrometers.

In one embodiment, a first groove is formed on the first base substrate;

a part of the first electrode layer is received in the first groove;

an orthographic projection of the first groove on the second base substrate (20) is included in an orthographic projection of the second electrode layer on the second base substrate.

In one embodiment, the first base substrate comprises a light shielding layer located in a non-display region of the liquid crystal display panel, and the first groove is arranged on the light shielding layer.

In one embodiment, a surface of a side of the first electrode layer facing the array substrate is provided with a second groove;

and an orthographic projection of the second groove on the second base substrate is included in an orthographic projection of the second electrode layer on the second base substrate.

In one embodiment, a width of the second groove is equal to a length of the second electrode layer extended along a width direction of the second groove.

In one embodiment, the second base substrate includes a redundant color resist layer formed by a plurality of redundant color resists, and the redundant color resist layer is located in a non-display region of the liquid crystal display panel;

every two adjacent redundant color resists are overlapped to form one protrusion, and the second electrode layer is arranged to be located above the redundant color resist layer and located between two adjacent protrusions.

In one embodiment, a space between the second electrode layer and the protrusion is between 0 micron and 5 microns.

In one embodiment, the second base substrate includes a substrate layer, a plurality of data wires being arranged on the substrate layer, the data wires includes a first group of wires located in a display region of the liquid crystal display panel and a second group of wires located in a non-display region of the liquid crystal display panel;

an orthographic projection of the first group of wires on the substrate layer is included in an orthographic projection of the second electrode layer on the substrate layer; an orthographic projection of the second group of wires on the substrate layer is included in or outside the orthographic projection of the second electrode layer on the substrate layer.

The liquid crystal display panel according to the present application has the following beneficial effects: in the liquid crystal display panel of the present application, the distance between the first electrode layer and the second electrode layer is greater than or equal to the critical safety distance that causes the generation of arc discharge between the first electrode layer and the second electrode layer, such that the generation of arc discharge between the first electrode layer and the second electrode layer after absorption of static electricity by the first electrode layer, the explosion of the second electrode layer and the damage to the second electrode layer due to the explosion of the second electrode layer are effectively avoided, and a condition that the splashing point generated due to the explosion of the second electrode layer falls within the display region of the liquid crystal display panel, and thereby affects a normal display of the liquid crystal display panel is further avoided.

A display device is further provided in one embodiment of the present application, this display device includes the liquid crystal display panel according to any one of the embodiments and a backlight module arranged on one side of the liquid crystal display panel.

The display device according to the present application has the following beneficial effects: the liquid crystal display panel is used in the display device, in the display device of the present application, the distance between the first electrode layer and the second electrode layer in the present application is greater than or equal to the critical safety distance that causes the generation of arc discharge between the first electrode layer and the second electrode layer, such that the generation of arc discharge between the first electrode layer and the second electrode layer after absorption of static electricity by the first electrode layer, the explosion of the second electrode layer and the damage to the second electrode layer due to the explosion of the second electrode layer are effectively avoided, a condition that the splashing point generated due to the explosion of the second electrode layer falls within the display region of the liquid crystal display panel, and thereby affects a normal display of the liquid crystal display panel is further avoided, and the quality of the display device is improved.

### BRIEF DESCRIPTION OF THE DRAWINGS

In order to describe the technical solutions in the embodiments of the present application more clearly, a brief introduction regarding the accompanying drawings that need to be used in describing the embodiments or the prior art is given below; it is obvious that the accompanying figures described below are merely some embodiments of the present application, the person of ordinary skill in the art can also obtain other drawings according to the current drawings without paying creative labor.

FIG. 1 illustrates a schematic structural diagram of a liquid crystal display panel according to a first embodiment of the present application;

FIG. 2 illustrates a schematic structural diagram of a liquid crystal display panel according to a second embodiment of the present application;

FIG. 3 illustrates a schematic structural diagram of a liquid crystal display panel according to a third embodiment of the present application;

FIG. 4 illustrates a schematic structural diagram of a liquid crystal display panel according to a fourth embodiment of the present application;

FIG. 5 illustrates a schematic structural diagram of a liquid crystal display panel according to a fifth embodiment of the present application;

FIG. 6 illustrates a schematic structural diagram of a liquid crystal display panel according to a sixth embodiment of the present application;

FIG. 7 illustrates a schematic structural diagram of a liquid crystal display panel according to a seventh embodiment of the present application;

FIG. 8 illustrates a schematic structural diagram of a liquid crystal display panel according to an eighth embodiment of the present application;

FIG. 9 illustrates a top view of an array substrate of the liquid crystal display panel according to any one of the first embodiment, the second embodiment, the third embodiment, the fourth embodiment, the fifth embodiment, the sixth embodiment, the seventh embodiment and the eighth embodiment of the present application; and

FIG. 10 illustrates a schematic structural diagram of a display device according to a ninth embodiment of the present application.

### DETAILED DESCRIPTION OF THE EMBODIMENTS

In order to make the purpose, the technical solution and the advantages of the present application be clearer and more understandable, the present application is further described in detail below with reference to accompanying figures and embodiments. It should be understood that, the embodiments described in detail herein are only intended to explain the present application but not to limit the present application.

It needs to be noted that, when one component is described to be “fixed to” or “arranged on” another component, this component may be directly or indirectly arranged on another component. When it is described that one component “is connected with” another component, this component may be directly or indirectly connected to the another component.

It needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used for description purposes, and should not be considered as indicating or implying any relative importance, or implicitly indicating the number of indicated technical features. As such, technical feature(s) restricted by “the first” or “the second” can explicitly or implicitly comprise one or more such technical feature(s). In the description of the present application, “a plurality of” means two or more, unless there is additional explicit and specific limitation.

A liquid crystal display panel and a display device are provided in the embodiments of the present application, so that a problem that the existing liquid crystal display panel has a weak anti-static-electricity ability, so that the electrodes of the existing liquid crystal display panel are prone to be damaged is solved.

### The First Embodiment

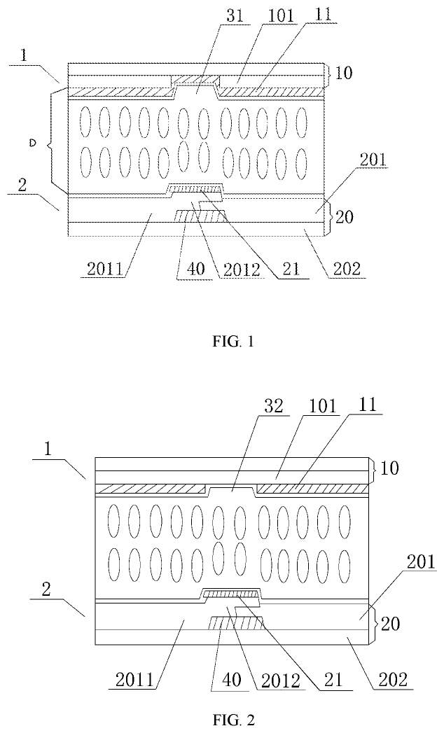

Referring to FIG. 1, a liquid crystal display panel according to the first embodiment of the present application includes a color film substrate 1 and an array substrate 2.

Where the color film substrate 1 includes a first base substrate 10 and a first electrode layer 11 arranged on the first base substrate 10; the array substrate 2 includes a second base substrate 20 and a second electrode layer 21 arranged on the second base substrate 20. A distance D between the second electrode layer 21 and the first electrode layer 11 is greater than or equal to a threshold value. The threshold value is a critical safety distance that causes a generation of an arc discharge.

According to the liquid crystal display panel provided by the embodiment of the present application, the distance D between the first electrode layer 11 of the color film substrate 1 and the second electrode layer 21 of the array substrate 2 is set to be greater than or equal to the threshold value which is the critical safety distance that causes the generation of arc discharge between the first electrode layer 11 and the second electrode layer 21, so that the arc discharge would not be generated between the first electrode layer 11 and the second electrode layer 21 after static electricity is absorbed by the first electrode layer 11, an anti-static-electricity ability of the liquid crystal display panel is enhanced, the second electrode layer 21 is further avoided from being damaged due to explosion, and a situation that a splashing point generated due to the explosion of the second electrode layer 21 falls within a display region 100 of the liquid crystal display panel, and thereby affects a normal display of the liquid crystal display panel is effectively avoided.

It should be noted that the arc discharge refers to the phenomenon that two electrodes are kept conductive by gaseous charged particles such as electrons or ions under a certain voltage. The arc discharge mainly emits an atomic spectral line which is commonly used excitation light source for emission spectrum analysis. Generally, the arc discharge is divided into DC (Direct Current) arc discharge and AC (Alternating Current) arc discharge. Arc discharge is the most intensively self-maintained discharge in gas discharge. When the power supply provides an electrical energy with greater power, an electrode gap voltage need not be too high (about tens of volts), a greater current (e.g., several to tens of amps) can pass through the gas or metal vapor in two electrodes continuously and emit intense light so as to generate high temperatures (e.g., from thousands of degrees of temperature to ten thousands of degrees of temperature), which is the arc discharge.

It can be understood that the critical safety distance that causes the generation of arc discharge between the first electrode layer 11 and the second electrode layer 21 is a minimum distance that does not cause the generation of arc discharge between the first electrode layer 11 and the second electrode layer 21, that is, the arc discharge is not generated between the first electrode layer 11 and the second electrode layer 21 when there is the minimum distance between the first electrode layer 11 and the second electrode layer 21. The generation of the arc discharge by the first electrode layer 11 is relevant with the distance D between the first electrode layer 11 and the second electrode layer 21, if a space between the two electrode layers is greater than a maximum distance that causes the generation of the arc discharge, the arc discharge won't be generated. Thus, in the present application, the distance D between the second electrode layer 21 and the first electrode layer 11 is set to be greater than or equal to the minimum distance that does not cause the generation of the arc discharge between the first electrode layer 11 and the second electrode layer 21, so that the generation of arc discharge can be effectively avoided.

The first electrode layer 11 and the second electrode layer 21 in this embodiment are made of a conductive material such as ITO (Indium Tin Oxide) film.

In another embodiment of the present application, the threshold value is 3 micrometers.

It can be understood that, an electrostatic test needs to be performed on the liquid crystal display panel to test an anti-static-electricity ability of the liquid crystal display panel before delivery. Generally, when an electrostatic test with no more than 15 kilovolts are performed at the periphery of the liquid crystal display panel and the liquid crystal display panel is not effected, it indicates that the liquid crystal display panel has a qualified anti-static-electricity ability; when an electrostatic test with more than 15 kilovolts are performed at the periphery of the liquid crystal display panel and the liquid crystal display panel is damaged, this does not means that the liquid crystal display panel has an unqualified anti-static-electricity ability. Therefore, the threshold value in the embodiment of the present application is set aiming at the electrostatic test with no more than 15 kilovolts, when the electrostatic test with 15 kilovolts is performed at the periphery of the liquid crystal display panel, the distance D between the first electrode layer 11 and the second electrode layer 21 is set to be 3 microns, so that the arc discharge won't be generated between the first electrode layer 11 and the second electrode layer 21.

In this embodiment of the present application, the distance D between the first electrode layer 11 and the second electrode layer 21 may be set to be greater than 3 micrometers, so that an avoidance of generation of arc discharge between the first electrode layer 11 and the second electrode layer 21 is better guaranteed. In one embodiment, since the greater the distance D between the first electrode layer 11 and the second electrode layer 21, the greater the thickness of the entire liquid crystal display panel, so that the maximum distance between the first electrode layer 11 and the second electrode layer 21 may be set to be 4 micrometers; in this way, not only the avoidance of generation of arc discharge between the first electrode layer 11 and the second electrode layer 21 is guaranteed, but also the thickness of the liquid crystal display panel will not be increased.

Referring to FIG. 1, in the first embodiment of the present application, a first groove 31 is formed on the first base substrate 10 and a part of the first electrode layer 11 is located in the first groove 31; an orthographic projection of the first groove 31 on the second base substrate 20 is located in an orthographic projection of the second electrode layer 21 on the second base substrate 20.

According to this arrangement, the first groove 31 is arranged on the first base substrate 10, and a part of the first electrode layer 11 is received in the first groove 31; furthermore, the orthographic projection of the first electrode layer 11 on the second base substrate 20 is located in the orthographic projection of the second electrode layer 21 on the second base substrate 20; due to this arrangement, the second electrode layer 21 is corresponding to the part of the first electrode layer 11 received in the first groove 31, a distance D between the second electrode layer 21 and the first electrode layer 11 received in the first groove 31 is greater than a distance D between the second electrode layer 21 and the first electrode layer 11 without the first groove 31. In particular, the distance D between the second electrode layer 21 and the first electrode layer 11 can be enabled to be greater than or equal to 3 micrometers by adjusting the depth of the first groove 31, so that the generation of arc discharge between the second electrode layer 21 and the first electrode layer 11 can be effectively avoided.

It is worth noting that, an orthographic projection of the first groove 31 on the second base substrate 20 is located in the orthographic projection of the second electrode layer 21 on the second base substrate 20, that is, a relationship of sizes of the first groove 31 and the second electrode layer 21 may be that a width of the first groove 31 is equal to a length of the second electrode layer 21 extended along a width direction of the first groove 31; due to this arrangement, a distance D between any position of the surface of the second electrode layer 21 and the first electrode layer 11 does not cause a generation of arc discharge, so that the anti-static-electricity ability of the liquid crystal display panel is enhanced; of course, the relationship of sizes of the first groove 31 and the second electrode layer 21 can also be that the width of the first groove 31 is smaller than the length of the second electrode layer 21 extended along a width direction of the first groove 31, in particular, the width of the first groove 31 is 3-5 microns smaller than the length of the second electrode layer 21 extended along the width direction of the first groove 31, so that it is guaranteed that the distance D between most positions of the surface of the second electrode layer 21 and the first electrode layer 11 meets the condition that does not cause the generation of arc discharge, and the liquid crystal display panel can be provided with the function of anti-static-electricity ability, the requirement of the manufacturer on manufacturing the first groove 31 is reduced, and it does not necessarily need to keep the width of the first groove 31 to be equal to the length of the second electrode layer 21 extended in the width direction of the first groove 31, so that the manufacturing efficiency of the liquid crystal display panel is greatly improved.

Referring to FIG. 1, in the first embodiment of the present application, the first base substrate 10 includes a light shielding layer 101, the light shielding layer 101 is located in a non-display region 200 of the liquid crystal display panel, and the first groove 31 is arranged on the light shielding layer 101.

It should be noted that the first base substrate 10 may either be composed of a polarizer, a glass substrate and the light shielding layer 101 laminated in sequence, or be composed of the glass substrate and the light shielding layer 101 laminated in sequence, the arrangement of the first base substrate 10 is not limited in the embodiments of the present application, as long as the first base substrate 10 has a certain thickness so as to meet a condition of forming the first groove 31. Since the non-display region 200 of the liquid crystal display panel is completely opaque, the light shielding layer 101 located in the non-display region 200 of the liquid crystal display panel refers to a black light-shielding film; since an edge of the first electrode layer 11 starts to absorb static electricity firstly, then, the entire of the first electrode layer 11 absorbs static electricity, the edge of the first electrode layer 11 which absorbs static electricity firstly has the highest voltage, and is most likely to generate a phenomenon of arc discharge, thus, the first groove 31 can be arranged on the light shielding layer 101 of the non-display region 200 of the liquid crystal display panel, such that the distance D between the first electrode layer 11 and the second electrode layer 21 can be increased at the position where the first electrode layer 11 is most likely to generate arc discharge, the condition of generation of arc discharge is destroyed, and the anti-static-electricity ability of the liquid crystal display panel is greatly enhanced.

Furthermore, since the light shielding layer 101 is located in the non-display region 200 of the liquid crystal display panel, so that the first groove 31 can be arranged on the light shielding layer 101 to simplify a manufacturing process, and the use of the material of the light shielding layer 101 can also be reduced, and the manufacturing cost of the liquid crystal display panel is saved. In particular, since the light shielding layer 101 has a smaller thickness, so that the first groove 31 arranged on the light shielding layer 101 can pass through the light shielding layer 101, which is equivalent to removing a portion of the light shielding layer 101, not only the amount of materials of the light shielding layer 101 is reduced, the workload of manufacturing of the first groove 31 is further reduced, so that the liquid crystal display panel is easier to be manufactured.

It should be understood that, the relationship of the sizes of the first groove 31 and the second electrode layer 21 can not be that the width of the first groove 31 is greater than the length of the second electrode layer 21 extended along the width direction of the first groove 31. In this situation, although it is guaranteed that the distance D between any position of the surface of the second electrode layer 21 and the first electrode 11 does not meet the condition of generation of arc discharge, the orthographic projection of a part of the first groove 31 on the second base substrate 20 is located outside the orthographic projection of the second electrode layer 21 on the second base substrate 20, this part of the first groove 31 is not covered by the light shielding layer 101, so that light can penetrate through a part of the non-display region 200 of the liquid crystal display panel corresponding to this part of the first groove 31, thereby affecting a display effect of the liquid crystal display panel.

### The Second Embodiment

Referring to FIG. 2, in the second embodiment of the present application, a surface of one side of the second groove 32 facing the array substrate 2 is provided with a second groove 32; and an orthographic projection of the second groove 32 on the second base substrate 20 is included in the orthographic projection of the second electrode layer 21 on the second base substrate 20.

Since the arc discharge is generated between the first electrode layer 11 and the second electrode layer 21, so that the second groove 32 can be arranged on the surface of the side of the second groove 32 facing the array substrate 2, and the orthographic projection of the second groove 32 on the second base substrate 20 is included in the orthographic projection of the second electrode layer 21 on the second base substrate 20, according to this arrangement, the position of the first electrode layer 11 that corresponds to the second electrode layer 21 is the second groove 32, the increasing of the depth of the second groove 32 can increase the distance D between the first electrode layer 11 and the second electrode layer 21, so that the generation of arc discharge between the second electrode layer 21 and the first electrode layer 11 is effectively avoided.

It should be noted that, in the structure of the liquid crystal display panel, the second groove 32 may penetrate through the first electrode layer 11, or may not penetrate through the first electrode layer 11; of course, if the second groove 32 does not penetrate through the first electrode layer 11, the depth of the first groove 31 should be arranged such that a distance between the second electric layer 21 and the bottom of the second groove 32 is greater than or equal to 3 micrometers, thereby avoiding the generation of arc discharge phenomenon between the first electrode layer 11 and the second electrode layer 21; if the second groove 32 penetrates through the first electrode layer 11, the position of the first electrode layer 11 which corresponds to the second electrode layer 21 is the first base substrate 10, that is, one condition (i.e., providing two electrodes) for generating arc discharge has been destroyed, the arc discharge phenomenon won't occur by only providing the second electrode layer 21, so that the generation of arc discharge between the second electrode layer 21 and the first electrode layer 11 is effectively avoided.

When the second groove 32 is arranged to penetrate through the first electrode layer 11, it should be understood that, the orthographic projection of the second groove 32 on the second base substrate 20 is included in the orthographic projection of the second electrode layer 21 on the second base substrate 20, that is, the relationship of sizes of the second groove 32 and the second electrode layer 21 may be that the width of the second groove 32 is equal to the length of the second electrode layer 21 extended along the width direction of the second groove 32, according to this arrangement, the part of the color film substrate 1 corresponding to any position of the surface of the second electrode layer 21 is the first base substrate 10, the arc discharge phenomenon would not occur by only providing the second electrode layer 21, so that the arc discharge between the second electrode layer 21 and the first electrode layer 11 is effectively avoided, and the anti-static ability of the liquid crystal display panel is enhanced; of course, the relationship of sizes of the second groove 32 and the second electrode layer 21 may also be that the width of the second groove 32 is less than the width of the second electrode layer 21 extended along the width direction of the second groove 32, according to this arrangement, avoidance of generation of the arc discharge between most of the positions of the surface of the second electrode layer 21 and the first electrode layer 11 is guaranteed, the liquid crystal display panel is also provided with the anti-static-electricity effect, it does not necessarily need to keep the width of the second groove 32 to be equal to the length of the second electrode layer 21 extended along the width direction of the second groove 32 in the manufacturing process, so that the requirement of the manufacturer on manufacturing the second groove 32 is reduced, and the manufacturing efficiency of the liquid crystal display panel is greatly improved.

### The Third Embodiment

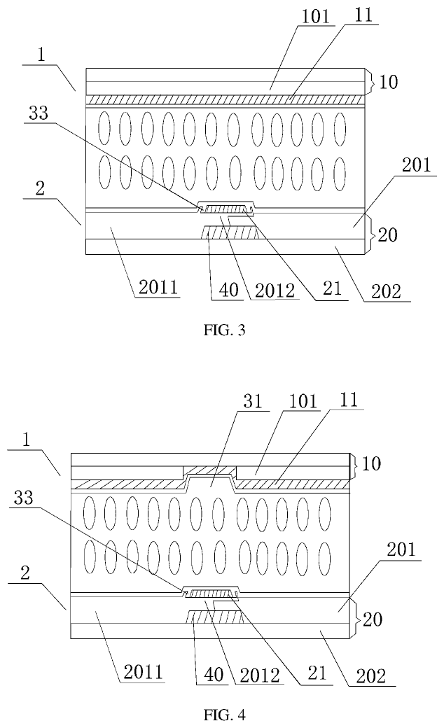

Referring to FIG. 3, in the third embodiment of the present application, a third groove 33 is formed on the second base substrate 20; and the second electrode layer 21 is located in the third groove 33.

In the present application, in addition to arranging the first groove 31 on the first base substrate 10 or arranging the second groove 32 on the first electrode layer 11 to increase the distance D between the first electrode layer 11 and the second electrode layer 21, the third groove 33 can also be arranged on the second base substrate 20 so that the second electrode layer 21 is received in the third groove 33, according to this arrangement, the distance D between the first electrode layer 11 and the second electrode layer 21 can be increased by increasing the depth of the third groove 33, and the generation of arc discharge between the first electrode layer 11 and the second electrode layer 21 is effectively avoided.

It should be noted that, the depth of the third groove 33 needs to meet a condition that the distance D between the first electrode layer 11 and the second electrode layer 21 is greater than or equal to 3 micrometers. The width of the third groove 33 may be greater than or equal to the length of the second electrode layer 21 extended along the width direction of the third groove 33, thereby ensuring that the entire of the second electrode layer 21 is received in the third groove 33, that is, the arc discharge won't be generated between any position of the second electrode layer 21 and the first electrode layer 11, so that the anti-static-electricity ability of the liquid crystal display panel is enhanced.

Referring to FIG. 3, there is an objective of increasing the distance D between the first electrode layer 11 and the second electrode layer 21 through the third groove 33 in third embodiment of the present application.

### The Fourth Embodiment

Referring to FIG. 4, the first groove 31 and the third groove 33 are provided simultaneously in the fourth embodiment of the present application, so that the distance D between the first electrode layer 11 and the second electrode layer 21 becomes greater, the generation of arc discharge between the first electrode layer 11 and the second electrode layer 21 is further avoided, and the anti-static-electricity ability of the liquid crystal display panel is enhanced.

### The Fifth Embodiment

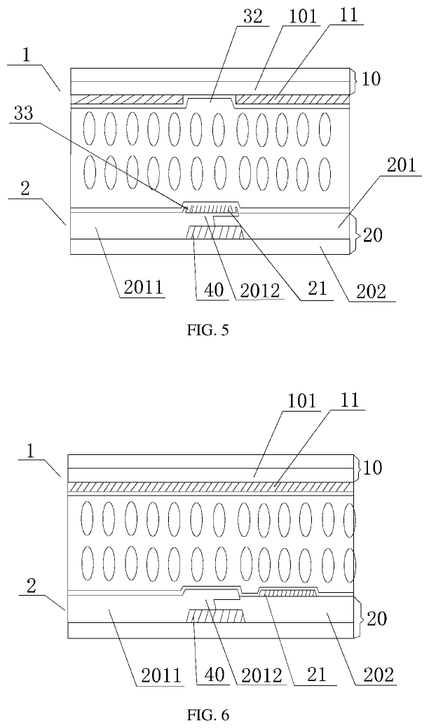

Referring to FIG. 5, a second groove 32 and a third groove 33 are provided simultaneously in the fifth embodiment of the present application, according to this arrangement, not only there is no first electrode layer 11 at a position of the color film substrate 1 corresponding to the second electrode layer 21, so that the generation of arc discharge between the first electrode layer 11 and the second electrode layer 21 is avoided, the distance D between the second electrode layer 21 and the first electrode layer 11 obliquely corresponding to the second electrode layer 21 is also increased, so that the first electrode layer 11 which obliquely corresponds to the second electrode layer 21 can be further avoided from generating the arc discharge towards the second electrode layer 21, and the anti-static-electricity ability of the liquid crystal display panel can be further improved.

### The Sixth Embodiment

Referring to FIG. 6, in the sixth embodiment of the present application, the second base substrate 20 includes a redundant color resist layer 201 formed by a plurality of redundant color resists 2011, the redundant color resist layer 201 is included in the non-display region 200 of the liquid crystal display panel; every two adjacent redundant color resists 2011 are overlapped to form one protrusion 2012, the second electrode layer 21 is located on the redundant color resist layer 201 and are arranged between two adjacent protrusions 2012.

It should be noted that, the second base substrate 20 may be composed of a polarizer, a glass substrate and a redundant color resist layer 201 laminated in sequence, or be composed of the glass substrate and the redundant color resist layer 201 laminated in sequence, and may also be composed of the glass substrate, the redundant color resist layer 201 and a flat layer laminated in sequence, the arrangement of the second base substrate 20 is not limited in the embodiments of the present application. In the sixth embodiment, the second base substrate 20 formed by sequentially laminating the glass substrate and the redundant color resist layer 201 is taken as an example, the second electrode layer 21 will be arranged on the redundant color resist layer 201, since every two adjacent redundant color resists 2011 are overlapped to form one protrusion 2012, in the redundant color resist layer 201; according to this arrangement, there are two options, that is, the second electrode layer 21 is arranged on the protrusion 2012 or arranged outside the protrusion 2012; due to the fact that the distance between the first electrode layer 11 and the protrusion 2012 is less than the distance between a redundant color resist 2011 of the redundant color resist layer 201 located outside the protrusion 2012 and the first electrode layer 11, so that the second electrode layer 21 can be arranged on the redundant color resist 2011 of the redundant color resist layer 201 located outside the protrusion 2012, and thus the second electrode layer 21 is located between two adjacent protrusions 2012, this arrangement of the second electrode layer 21 can increase the distance D between the first electrode layer 11 and the second electrode layer 21 as compared to arranging the second electrode layer 21 on the protrusion 2012, thereby avoiding the generation of arc discharge between the first electrode layer 11 and the second electrode layer 21.

It can be understood that, the plurality of redundant color resists 2011 included in the redundant color resist layer 201 are color resist blocks, and these color resist blocks are red color resist blocks, green color resist blocks and blue color resist blocks, and are made of red resin material, green resin material and blue resin material, respectively.

Referring to FIG. 6, it can be seen that when the second electrode layer 21 is located between two adjacent protrusions 2012, the first groove 31 or the second groove 32 or the third groove 33 is no longer provided in the sixth embodiment of the present application.

In one embodiment, a space between the second electrode layer 21 and the protrusion 2012 is between 0-5 μm. The second electrode layer 21 may be arranged at any position between two adjacent protrusions 2012; however, under consideration of the difficulty of manufacturing process, the space between the second electrode layer 21 and the protrusion 2012 may be set to be between 0-5 μm, so that the difficulty in manufacturing is reduced, the workload is reduced, and the manufacturing efficiency of the liquid crystal display panel is improved.

### The Seventh Embodiment

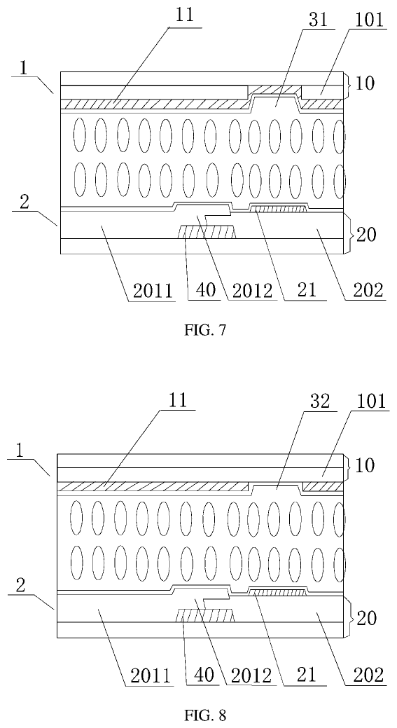

Referring to FIG. 7, based on the sixth embodiment, when the second electrode layer 21 is located between two adjacent protrusions 2012, the first groove 31 is further provided in the seventh embodiment of the present application, so that the distance D between the first electrode layer 11 and the second electrode layer 21 is further increased.

### The Eighth Embodiment

Referring to FIG. 8, based on the sixth embodiment, when the second electrode layer 21 is located between two adjacent protrusions 2012, the second groove 32 can be provided in the eighth embodiment of the present application, so that the distance D between the first electrode layer 11 and the second electrode layer 21 can be increased.

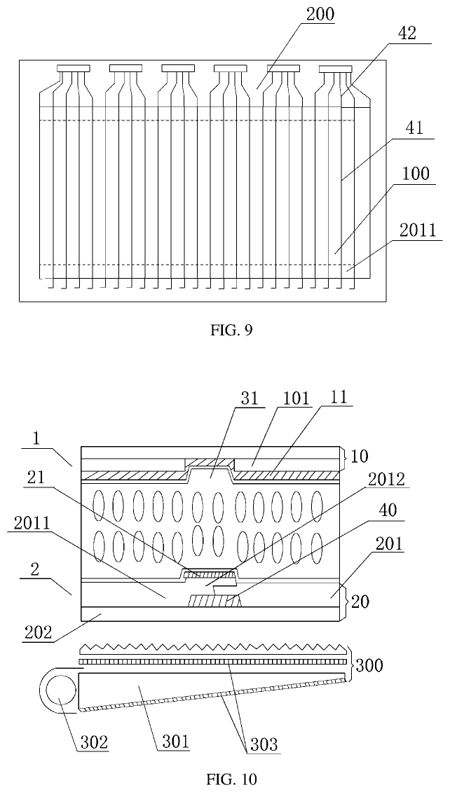

Referring to FIG. 9, in the liquid crystal display panel according to the first embodiment, the second embodiment, the third embodiment, the fourth embodiment, the fifth embodiment, the sixth embodiment, the seventh embodiment and the eighth embodiment of the present application, the second base substrate 20 includes a substrate layer 202, a plurality of data wires being arranged on the substrate layer 202, the data wires 40 include a first group of wires 41 located in the display region 100 of the liquid crystal display panel and a second group of wires 42 located in the non-display region 200 of the liquid crystal display panel; an orthographic projection of the first group of wires 41 on the substrate layer 202 is included in an orthographic projection of the second electrode layer 21 on the substrate layer 202, and an orthographic projection of the second group of wires 42 on the substrate layer 202 is included in or outside an orthographic projection of the second electrode layer 21 on the substrate layer 202.

The substrate layer 202 is a glass substrate, the data wires 40 may be arranged on the array substrate 2 of the liquid crystal display panel, the data wires 40 are extended in a first direction and are arranged in a second direction, the first direction and the second direction are perpendicular to each other, the data wires 40 can pass through the display region 100 and the non-display region 200 of the liquid crystal display panel, so that the data wires 40 are divided into the first group of wires 41 and a second group of wires 42, a color resist layer is covered on the first group of wires 41 of the data wires 40, and the redundant color resist layer 201 are covered on the second group of wires 42, the color resist layer and the redundant color resit layer 201 are continuously extended and integrally formed structure, and the color resist layer is located in the display region 100 of the liquid crystal display panel; in order to shield a stray capacitance between the data wires 40 and the first electrode layer 11, the second electrode layer 21 may be arranged on the data wires 40, and the protrusions 2012 can be arranged between the second electrode layer 21 and the data wires 40 in order to avoid an influence of signal transmission due to too close distance between the second electrode layer 21 and the data wires 40, however, the distance D between the second electrode layer 21 and the position of the first electrode layer 11 is reduced due to this arrangement, thus, the second electrode layer 21 located in the non-display region 200 of the liquid crystal display panel may be moved, for example, the second electrode layer 21 may be moved to a position between the two protrusions 2012, according to this arrangement, the orthographic projection of the second group of wires 42 on the substrate layer 202 is located outside the orthographic projection of the second electrode layer 21 on the substrate layer 202; the first groove 31, the second groove 32 or the third groove 33 can also be arranged, so that the orthographic projection of the second group of wires 42 on the substrate layer 202 is included in the orthographic projection of the second electrode layer 21 on the substrate layer 202.

### The Ninth Embodiment

Referring to FIG. 10, a display device is provided in the ninth embodiment of the present application, the display device includes the liquid crystal display panel according to any one of the aforesaid embodiments and the backlight module 300 arranged on one side of the liquid crystal display panel.

The backlight module 300 includes a light guide plate 301, a light source module 302, and an optical film 303. The backlight module 300 is configured to provide illumination for the liquid crystal display panel.

In application of the display device, the display device may be a device having displaying function, such as a desktop computer, a notebook computer, a tablet computer, a television, a screen, an advertising displayer, a large screen for advertisement, etc.

The display device according to the present application has the following beneficial effects: the display device is provided with the aforesaid liquid crystal display panel, the distance D between the first electrode layer 11 and the second electrode layer 21 in the present application is greater than or equal to the critical safety distance that causes the generation of arc discharge between the first electrode layer 11 and the second electrode layer 21, so that a condition of generation of arc discharge between the first electrode layer 11 and the second electrode layer 21 after absorption of static electricity by the first electrode layer 11, the explosion of the second electrode layer 21 and the damage to the second electrode layer 21 due to the explosion of the second electrode layer 21 is effectively avoided, and a condition that the splashing point generated due to the explosion of the second electrode layer 21 falls within the display region 100 of the liquid crystal display panel, and thereby affects a normal display of the liquid crystal display panel is further avoided, so that the quality of the display device is improved.

The aforesaid embodiments are only some specific embodiments of the present application; however, the protection scope of the present application is not limited by these embodiments. A person skilled in the art can easily think out changes or replacements of the technical solutions within the technical scope of the present application, and these changes or replacements should all be included in the protection scope of the present application. Thus, the protection scope of the present application should be determined by the protection scope of the claims.

What is claimed is:

1. A liquid crystal display panel, comprising: a color film substrate and an array substrate, the color film substrate comprises a first base substrate and a first electrode layer arranged on the first base substrate, the array substrate comprises a second base substrate and a second electrode layer arranged on the second base substrate, wherein:
a distance between the second electrode layer and the first electrode layer is greater than or equal to a threshold value, and the threshold value is a critical safety distance that causes a generation of an arc discharge between the first electrode layer and the second electrode layer.

2. The liquid crystal display panel according to claim 1, wherein the threshold value is 3 micrometers.

3. The liquid crystal display panel according to claim 2, wherein a first groove is formed on the first base substrate;
a part of the first electrode layer is received in the first groove; and
an orthographic projection of the first groove on the second base substrate is included in an orthographic projection of the second electrode layer on the second base substrate.

4. The liquid crystal display panel according to claim 3, wherein the first base substrate comprises a light shielding layer located in a non-display region of the liquid crystal display panel, and the first groove is arranged on the light shielding layer.

5. The liquid crystal display panel according to claim 2, wherein a surface of a side of the first electrode layer facing the array substrate is provided with a second groove;
and an orthographic projection of the second groove on the second base substrate is included in an orthographic projection of the second electrode layer on the second base substrate.

6. The liquid crystal display panel according to claim 3, wherein a width of the first groove is smaller than a length of the second electrode layer extended along a width direction of the first groove, and a difference between the width of the first groove and the length of the second electrode layer extended along the width direction of the first groove is between 3 micrometers and 5 micrometers.

7. The liquid crystal display panel according to claim 1, wherein the second base substrate comprises a redundant color resist layer formed by a plurality of redundant color resists, and the redundant color resist layer is located in a non-display region of the liquid crystal display panel; and
every two adjacent redundant color resists are overlapped to form one protrusion, and the second electrode layer is arranged to be located above the redundant color resist layer and located between two adjacent protrusions.

8. The liquid crystal display panel according to claim 7, wherein a space between the second electrode layer and the protrusion is between 0 micron and 5 microns.

9. The liquid crystal display panel according to claim 1, wherein the second base substrate comprises a substrate layer, a plurality of data wires being arranged on the substrate layer, the data wires comprises a first group of wires located in a display region of the liquid crystal display panel and a second group of wires located in a non-display region of the liquid crystal display panel;
an orthographic projection of the first group of wires on the substrate layer is included in an orthographic projection of the second electrode layer on the substrate layer; and
an orthographic projection of the second group of wires on the substrate layer is included in or outside the orthographic projection of the second electrode layer on the substrate layer.

10. A display device, comprising: a liquid crystal display panel and a backlight module arranged on one side of the liquid crystal display panel;
wherein the liquid crystal display panel comprises a color film substrate and an array substrate, the color film substrate comprises a first base substrate and a first electrode layer arranged on the first base substrate, the array substrate comprises a second base substrate and a second electrode layer arranged on the second base substrate, wherein:
a distance between the second electrode layer and the first electrode layer is greater than or equal to a threshold value, and the threshold value is a critical safety distance that causes a generation of an arc discharge between the first electrode layer and the second electrode layer.

11. The display device according to claim 10, wherein the threshold value is 3 micrometers.

12. The display device according to claim 11, wherein a first groove is formed on the first base substrate;
a part of the first electrode layer is received in the first groove; and
an orthographic projection of the first groove on the second base substrate is included in an orthographic projection of the second electrode layer on the second base substrate.

13. The display device according to claim 12, wherein the first base substrate comprises a light shielding layer located in a non-display region of the liquid crystal display panel, and the first groove is arranged on the light shielding layer.

14. The display device according to claim 11, wherein a surface of a side of the first electrode layer facing the array substrate is provided with a second groove;
and an orthographic projection of the second groove on the second base substrate is included in an orthographic projection of the second electrode layer on the second base substrate.

15. The display device according to claim 12, wherein a width of the first groove is smaller than a length of the second electrode layer extended along a width direction of the first groove, and a difference between the width of the first groove and the length of the second electrode layer extended along the width direction of the first groove is between 3 micrometers and 5 micrometers.

16. The display device according to claim 10, wherein the second base substrate comprises a redundant color resist layer formed by a plurality of redundant color resists, and the redundant color resist layer is located in a non-display region of the liquid crystal display panel; and
every two adjacent redundant color resists are overlapped to form one protrusion, and the second electrode layer is arranged to be located above the redundant color resist layer and located between two adjacent protrusions.

17. The display device according to claim 16, wherein a space between the second electrode layer and the protrusion is between 0 micron and 5 microns.

18. The display device according to claim 10, wherein the second base substrate comprises a substrate layer, a plurality of data wires being arranged on the substrate layer, the data wires comprises a first group of wires located in a display region of the liquid crystal display panel and a second group of wires located in a non-display region of the liquid crystal display panel;
an orthographic projection of the first group of wires on the substrate layer is included in an orthographic projection of the second electrode layer on the substrate layer; and
an orthographic projection of the second group of wires on the substrate layer is included in or outside the orthographic projection of the second electrode layer on the substrate layer.
